(19) United States
(12) Patent Application Publication
(10) Pub. No.: US 2014/0220461 A1
(43) Pub. Date: Aug. 7, 2014

(54) AIR BATTERY, MOBILE OBJECT COMPRISING THE AIR BATTERY AND METHOD FOR USING AN AIR BATTERY

(71) Applicant: Sanae Okazaki, Suntou-gun (JP)

(72) Inventor: Sanae Okazaki, Suntou-gun (JP)

(73) Assignee: TOYOTA JIDOSHA KABUSHIKI KAISHA, Toyota-shi, Aichi (JP)

(21) Appl. No.: 14/345,737

(22) PCT Filed: Oct. 13, 2011
(86) PCT No.: PCT/JP2011/073571

§ 371 Date: Apr. 10, 2014

(51) Int. Cl. H01M 12/08

(52) U.S. Cl. CPC H01M 12/08
USPC 429/405

(57) ABSTRACT

An object of the invention is to provide an air battery that can avoid anode corrosion and withstand long-term use and storage, a mobile object including the air battery, and a method for using an air battery. Disclosed is an air battery including an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode includes at least an anode active material layer and an anode current collector in order from the closest to the liquid electrolyte layer, and wherein the anode active material layer and the anode current collector are present on the upper side of the vertical direction and above the liquid electrolyte layer.

### TECHNICAL FIELD

The present invention relates to an air battery that can avoid anode corrosion and withstand long-term use and storage, a mobile object comprising the air battery, and a method for using an air battery.

### BACKGROUND ART

An air battery is a battery capable of charge and discharge, using a metal or metal compound as the anode active material and oxygen as the cathode active material. Since the cathode active material, oxygen, can be obtained from the air, it is not needed to encapsulate the cathode active material in the battery. Therefore, in theory, the air battery can realize a larger capacity than a secondary battery comprising a solid cathode active material.

In a lithium-air battery, which is a kind of air battery, the reaction described by the following formula (I) proceeds at the anode, upon discharge:

2Li→2Li⁺2e⁻ (I)

Electrons generated in the formula (I) pass through an external circuit, work by an external load and then reach the air electrode. Then, the lithium ions (2Li⁺) generated in the formula (I) are transferred by electro-osmosis from the anode side to the air electrode side through the electrolyte sandwiched between the anode and the air electrode.

Also, the reactions described by the following formulae (II) and (III) proceed at the air electrode, upon discharge:

2Li⁺+O₂+2e⁻Li₂O₂ (II)

2Li⁺+½O₂+2e⁻→Li₂O (III)

The lithium peroxide (Li₂O₂) and lithium oxide (Li₂O) thus generated are stored in the air electrode in the form of a solid.

Upon charge, a reaction which is reverse to the reaction described by the formula (I) proceeds at the anode, while reactions which are reverse to the reactions described by the formulae (II) and (III) proceed at the air electrode. Therefore, the lithium metal is regenerated at the anode and allows the battery to re-discharge.

An outer case made of a laminated film has been used as the outer case of an air battery. A technique relating to non-aqueous electrolyte air battery is disclosed in Patent Literature 1, in which a power generation unit(s) comprising a cathode, an anode and an electrolyte layer is housed in an outer case made of a laminated film (Paragraph [0008] of the Description of Patent Literature 1, and FIG. 1 of Patent Literature 1).

### CITATION LIST

Patent Literature 1: Japanese Patent Application Laid-Open No. 2003-7357

### SUMMARY OF INVENTION

### Technical Problem

The inventor of the present invention provided further insights into the air battery disclosed in Patent Literature 1, the battery comprising an outer case made of a laminated film. Therefore, the inventor has found that there is a possibility that a liquid derived from a liquid electrolyte layer inside an air battery, penetrates between other members inside the air battery.

The present invention was achieved in light of the above circumstance. An object of the present invention is to provide an air battery that can avoid anode corrosion and withstand long-term use and storage, a mobile object comprising the air battery, and a method for using an air battery.

### Solution to Problem

A first air battery of the present invention comprises an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode comprises at least an anode active material layer and an anode current collector in order from the closest to the liquid electrolyte layer, and wherein the anode active material layer and the anode current collector are present on the upper side of the vertical direction and above the liquid electrolyte layer.

The first air battery of the present invention preferably comprises a mark indicating at least any one of a state in which the air electrode is present on the lower side of the vertical direction of the laminate, and a state in which the anode is present on the upper side of the vertical direction of the laminate.

The first air battery of the present invention can further comprise a housing for housing the one or two or more outer cases stacked, and the mark can be provided on a side surface of the housing, the side surface being parallel to the direction of the stacking direction of the outer cases.

In the first air battery of the present invention, the anode active material layer can comprise a lithium metal.

In the first air battery of the present invention, the anode current collector can comprise a metal or alloy.

In the first air battery of the present invention, the liquid electrolyte layer can comprise an ionic liquid.

In the first air battery of the present invention, the outer case can be made of a laminated film.

A mobile object of the present invention comprises the above air battery.

In the mobile object of the present invention, preferably, the anode active material layer and the anode current collector are always present on the upper side of the vertical direction and above the liquid electrolyte layer.

A second air battery of the present invention comprises an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode comprises at least an anode active material layer and an anode current collector in order from the closest to the liquid electrolyte layer, and wherein the anode active material layer and the anode current collector are present on the upper side of the vertical direction and above the liquid electrolyte layer, so that a liquid derived from the liquid electrolyte layer is not present at side surfaces of and/or an interface between the anode active material layer and the anode current collector.

A method for using an air battery according to the present invention, comprises an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode comprises at least an anode active material layer and an anode current collector in order from the closest to the liquid electrolyte layer, and wherein the vertical direction of the air battery is determined so that at least at the point of use, the anode active material layer and the anode current collector are present on the upper side of the vertical direction and above the liquid electrolyte layer.

In the method for using the air battery according to the present invention, the vertical direction of the air battery can be determined based on a mark indicating at least any one of a state in which the air electrode is present on the lower side of the vertical direction of the laminate, and a state in which the anode is present on the upper side of the vertical direction of the laminate.

In the method for using the air battery according to the present invention, the air battery can further comprise a housing for housing the one or two or more outer cases stacked, wherein the mark is provided on a side surface of the housing, the side surface being parallel to the direction of the stacking direction of the outer cases.

In the method for using the air battery according to the present invention, the anode active material layer can comprise a lithium metal.

In the method for using the air battery according to the present invention, the anode current collector can comprise a metal or alloy.

In the method for using the air battery according to the present invention, the liquid electrolyte layer can comprise an ionic liquid.

In the method for using the air battery according to the present invention, the outer case can be made of a laminated film.

### Advantageous Effects of Invention

According to the present invention, the anode active material layer and the anode current collector are present on the upper side of the vertical direction and above the liquid electrolyte layer, so that it is possible to prevent contact between the liquid derived from the liquid electrolyte layer and the side surfaces of the anode active material layer and the anode current collector. As a result, it is possible to prevent the formation of an internal battery between the anode active material layer, the anode current collector and the liquid from occurring, and it is possible to prevent the generation of corrosion current that can corrode the anode.

### BRIEF DESCRIPTION OF DRAWINGS

FIG. 1 is a view showing a first typical example of the air battery of the present invention, and it is also a schematic cross-sectional view of the air battery cut in the laminating direction.

FIG. 2 are views showing a second typical example of the air battery of the present invention, and they are also schematic cross-sectional views of the air battery cut in the laminating direction.

FIG. 3 are views showing a third typical example of the air battery of the present invention, and they are also schematic cross-sectional views of the air battery cut in the laminating direction.

FIG. 4 are views showing a fourth typical example of the air battery of the present invention, and they are also schematic cross-sectional views of the air battery cut in the laminating direction.

FIG. 5 are views showing a fifth typical example of the air battery of the present invention, and they are also schematic cross-sectional views of the air battery cut in the laminating direction.

FIG. 6 are views showing a sixth typical example of the air battery of the present invention, and they are also schematic cross-sectional views of the air battery cut in the laminating direction.

FIG. 7 are views showing an example of the layer structure of a conventional air battery, and they are also schematic cross-sectional views of the conventional air battery cut in the laminating direction.

### DESCRIPTION OF EMBODIMENTS

### 1. Air Battery and Method for Using Air Battery

A first air battery of the present invention comprises an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode comprises at least an anode active material layer and an anode current collector in order from the closest to the liquid electrolyte layer, and wherein the anode active material layer and the anode current collector are present on the upper side of the vertical direction and above the liquid electrolyte layer.

A second air battery of the present invention comprises an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode comprises at least an anode active material layer and an anode current collector in order from the closest to the liquid electrolyte layer, and wherein the anode active material layer and the anode current collector are present on the upper side of the vertical direction and above the liquid electrolyte layer, so that a liquid derived from the liquid electrolyte layer is not present at side surfaces of and/or an interface between the anode active material layer and the anode current collector.

A method for using an air battery according to the present invention, comprises an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer, wherein the anode comprises at least an anode active material layer and an anode current collector in order from the closest to the liquid electrolyte layer, and wherein the vertical direction of the air battery is determined so that at least at the point of use, the anode active material layer and the anode current collector are present on the upper side of the vertical direction and above the liquid electrolyte layer.

The first air battery, the second air battery and the method for using an air battery according to the present invention, share the following common features: the air battery comprises an air electrode, an anode, a liquid electrolyte layer and an outer case; the anode comprises at least an anode active material layer and an anode current collector in order from the closest to the liquid electrolyte layer; and the anode active material layer and the anode current collector are present on the upper side of the vertical direction and above the liquid electrolyte layer.

In this Description, hereinafter, the first air battery will be mainly explained. Then, as needed, the second air battery and the method for using an air battery will be described.

In the present invention, “the anode active material layer and the anode current collector are present on the upper side of the vertical direction and above the liquid electrolyte layer” means the following positional relationship between the anode active material layer, the anode current collector and the liquid electrolyte layer. That is, the positional relationship is such a relationship that when a line is dropped from any part of the anode active material layer and the anode current collector to the lower side of the vertical direction, the line may touch the liquid electrolyte layer; however, when a line is dropped from any part of the liquid electrolyte layer to the lower side of the vertical direction, the line does not touch the anode active material layer or the anode current collector.

As shown in the below-described Comparative Example 1, the inventor of the present invention allowed an air battery to stand for one week, the battery comprising an air electrode current collector, an air electrode layer, a liquid electrolyte layer, a lithium metal and an anode current collector (air electrode current collector-air electrode layer-liquid electrolyte layer-lithium metal-anode current collector) which were stacked in this order from the upper side of the vertical direction. As a result, it has been found that while the initial voltage of the air battery was 2.7 V, the open-circuit voltage of the air battery after it was allowed to stand for one week was 2.2 V, and the voltage of the air battery after it was allowed to stand for one week was 0.5 V lower than the initial battery.

The inventor has found out the following: a main cause of the decrease in voltage is that in an air battery after being allowed to stand for a long term, a liquid derived from the liquid electrolyte layer seeps out by gravity to the lower side of the vertical direction.

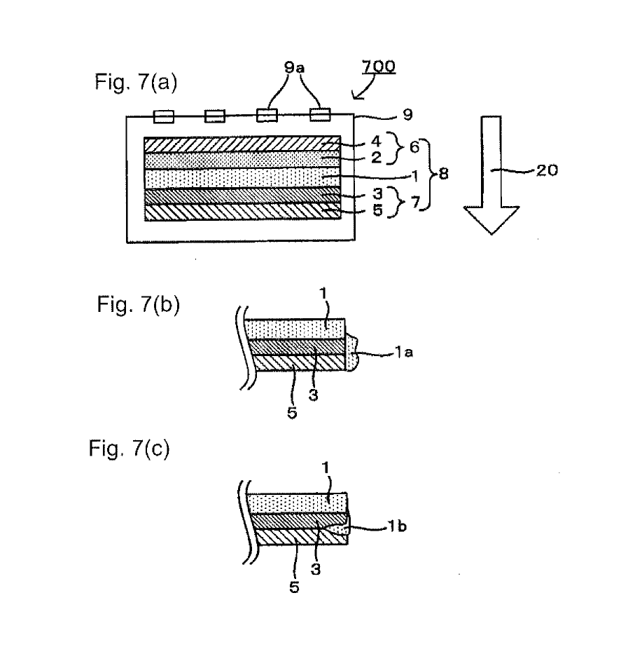

FIG. 7(a) is a view showing an example of the layer structure of a conventional air battery, and it is also a schematic cross-sectional view of the conventional air battery cut in the laminating direction. In FIG. 7(a), an arrow 20 indicates the vertical direction.

A conventional air battery 700 comprises the following: an air electrode 6 comprising an air electrode layer 2 and an air electrode current collector 4; an anode 7 comprising an anode active material layer 3 and an anode current collector 5; a liquid electrolyte layer 1 sandwiched between the air electrode 6 and the anode 7; and an outer case 9 housing a laminate 8 comprising the air electrode 6, the anode 7 and the liquid electrolyte layer 1. As shown in FIG. 7(a), in the laminate 8, the members are stacked in the following order from the upper side of the vertical direction: air electrode current collector 4-air electrode layer 2-liquid electrolyte layer 1-anode active material layer 3-anode current collector 5. The outer case 9 comprises oxygen intake vents 9a on the side facing the air electrode 6.

FIG. 7(b) is a schematic cross-sectional view of a part of the conventional air battery 700 after being allowed to stand for a long term. In FIG. 7(b), parts of the liquid electrolyte layer 1, the anode active material layer 3 and the anode current collector 5 are shown. In FIG. 7(b), a double wavy line indicates that the figure is partly omitted. As shown in FIG. 7(b), inside the air battery after being allowed to stand for a long term, a liquid 1a derived from the liquid electrolyte inside the liquid electrolyte layer 1 seeps out by gravity to side surfaces of the anode active material layer 3 and the anode current collector 5, so that the side surfaces of the anode active material layer 3 and the anode current collector 5 are wet with the liquid 1a. As a result, an internal battery is formed by the liquid 1a, the anode active material layer 3 and the anode current collector 5 to pass a corrosion current, thus promoting anode corrosion.

As well as FIG. 7(b), FIG. 7(c) is a schematic cross-sectional view of a part of the conventional air battery 700 after being allowed to stand for a long term. As shown in FIG. 7(c), inside the air battery after being allowed to stand for a long term, there is a possibility that a liquid 1b derived from the liquid electrolyte inside the liquid electrolyte layer 1 is dropped from the liquid electrolyte layer 1 by gravity and seeps into the interface between the anode active material layer 3 and the anode current collector 5, wetting the interface with the liquid 1b. As a result, an internal battery is formed by the liquid 1b, the anode active material layer 3 and the anode current collector 5 to pass a corrosion current, thus promoting anode corrosion.

The phenomena shown in FIGS. 7(b) and 7(c) are considered to occur not only when the air battery is stopped but also when the air battery is operated.

Methods for preventing anode corrosion are considered to include (1) a method of using a corrosion-resistance material in the anode current collector, such as tantalum or nickel; (2) a method of using a battery structure having no interface between the anode active material and the anode current collector; and (3) a method of solidifying the liquid electrolyte to prevent the liquid derived from the liquid electrolyte layer from leaking.

However, in the case of using the method (1), there may be a problem with cost reduction. Even in the case of using the method (2), it is inevitable that an interface will be formed between the anode active material and the anode current collector, especially during a long-term storage and/or use of the air battery; therefore, the method (2) is not considered to be effective. Also, in general, the liquid electrolyte solidified has low ion conductivity, so that the method (3) is considered to be less practical.

As a result of diligent researches, the inventor of the present invention has found that by placing the anode active material layer and the anode current collector on the upper side of the vertical direction and above the liquid electrolyte layer, it is possible to prevent contact between the liquid derived from the liquid electrolyte layer and the side surfaces of and/or the interface between the anode active material layer and the anode current collector. The inventor of the present invention has found that by using the air battery of the above structure, it is possible to prevent the formation of the internal battery between the anode active material layer, the anode current collector and the liquid from occurring, to prevent the generation of the corrosion current that can corrode the anode, and to increase the long-term storage and use properties of the air battery. Based on these findings, the inventor of the present invention accomplished the present invention.

In the present invention, the air battery is not particularly limited, as long as the air battery has such a structure that the anode active material layer and the anode current collector are present on the upper side of the vertical direction and above the liquid electrolyte layer. By using such a structure, the liquid derived from the liquid electrolyte layer is not present at the side surfaces of and/or the interface between the anode active material layer and the anode current collector. The liquid derived from the liquid electrolyte layer encompasses the liquid electrolyte itself and liquids produced by the reaction of the liquid electrolyte and other members.

In general, there are few opportunities to visually observe the inside of the air battery from the outside of the outer case. Even if the inside of the air battery can be visually observed from the outside of the outer case, it is difficult to correctly confirm the internal structure of the air battery from the outside, at the time of installing or using the air battery. Accordingly, some sort of mark can be provided on the outer case itself or on a member present outside the outer case (such as the below-described current collector tab or housing) to determine the orientation of the vertical direction of the air battery, based on the mark, at the time of designing or installing the air battery, for example.

The size, shape and color of the mark are not particularly limited. The mark is not limited to a character mark or symbol mark, and it can be a mark using the form of the whole or a part of a member (such as notch). However, preferred is a mark that enables visual confirmation of the orientation of the air battery, especially the vertical direction of the air battery at a glance. The number of the marks per air battery can be one or more. The marks can be provided on different members of the air battery.

For example, the mark can be provided on a current collector tab exposed on the outside of the outer case.

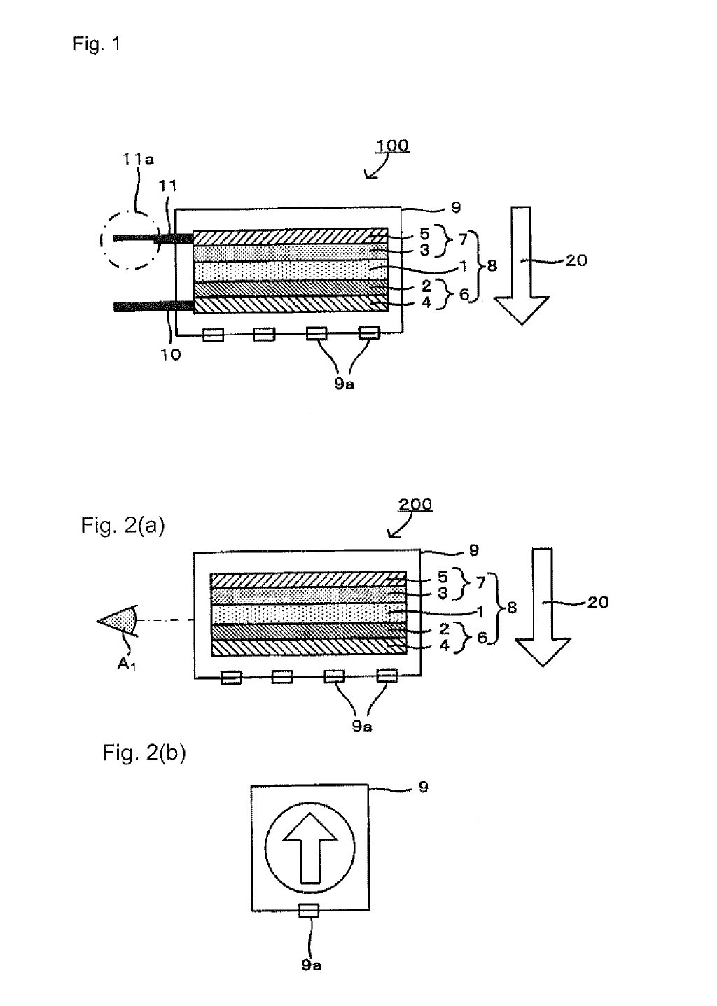

FIG. 1 is a view showing a first typical example of the air battery of the present invention, and it is also a schematic cross-sectional view of the air battery cut in the laminating direction. An arrow 20 indicates the vertical direction.

The first typical example 100 of the air battery of the present invention comprises the following: an air electrode 6 comprising an air electrode layer 2 and an air electrode current collector 4; an anode 7 comprising an anode active material layer 3 and an anode current collector 5; a liquid electrolyte layer 1 sandwiched between the air electrode 6 and the anode 7; and an outer case 9 housing a laminate 8 comprising the air electrode 6, the anode 7 and the liquid electrolyte layer 1. As shown in FIG. 1, in the laminate 8, the members are stacked in the following order from the upper side of the vertical direction: anode current collector 5-anode active material layer 3-liquid electrolyte layer 1-air electrode layer 2-air electrode current collector 4. The outer case 9 comprises oxygen intake vents 9a on the side facing the air electrode 6.

The first typical example 100 further comprises an air electrode current collector tab 10 and an anode current collector tab 11, which are connected to the air electrode current collector 4 and the anode current collector 5, respectively. A notch 11a is present at the tip of the anode current collector tab 11, and the notch 11a makes it possible to differentiate between the air electrode current collector tab 10 and the anode current collector tab 11.

As just described, the first typical example 100 comprising the anode current collector tab 11 with the notch 11a, makes it possible to visually and clearly confirm the top and bottom of the air battery (that is, the orientation of the vertical direction of the air battery to be installed) from the outside, at the time of installing and/or using the air battery. Therefore, the air battery can be certainly installed and/or used so that the anode active material layer 3 and the anode current collector 5 are on the upper side of the vertical direction and above the liquid electrolyte layer 1.

The mark can be a mark indicating a state in which the air electrode is present on the lower side of the vertical direction of the laminate, and/or a state in which the anode is present on the upper side of the vertical direction of the laminate. By providing such a mark, the top and bottom of the air battery can be confirmed from the outside of the air battery.

FIG. 2(a) is a view showing a second typical example of the air battery of the present invention, and it is also a schematic cross-sectional view of the air battery cut in the laminating direction. An arrow 20 indicates the vertical direction.

As shown in FIG. 2(a), as with the above-mentioned first typical example 100, the second typical example 200 of the air battery of the present invention comprises an outer case 9 housing a laminate 8. In the laminate 8, the members are staked in the following order from the upper side of the vertical direction: anode current collector 5-anode active material layer 3-liquid electrolyte layer 1-air electrode layer 2-air electrode current collector 4. The outer case 9 comprises oxygen intake vents 9a on the side facing the air electrode 6.

FIG. 2(b) is a view showing a side surface of the outer case 9, that is, a view showing a surface of the outer case 9 as seen from a viewpoint A₁ in FIG. 2(a). As shown in FIG. 2(b), the second typical example 200 has a mark of arrow on the side surface of the outer case. The orientation indicated by the arrow shows the place of the anode in the outer case. By this arrow mark, the top and bottom of the outer case can be determined.

As just described, the second typical example 200 with the arrow mark on the side surface of the outer case 9, makes it possible to visually and clearly confirm the top and bottom of the air battery from the outside, at the time of installing and/or using the air battery. Therefore, the air battery can be certainly installed and/or used so that the anode active material layer 3 and the anode current collector 5 are on the upper side of the vertical direction and above the liquid electrolyte layer 1.

In the present invention, the air battery can have such a structure that the two or more laminates each comprising the air electrode, the anode and the liquid electrolyte layer, are stacked.

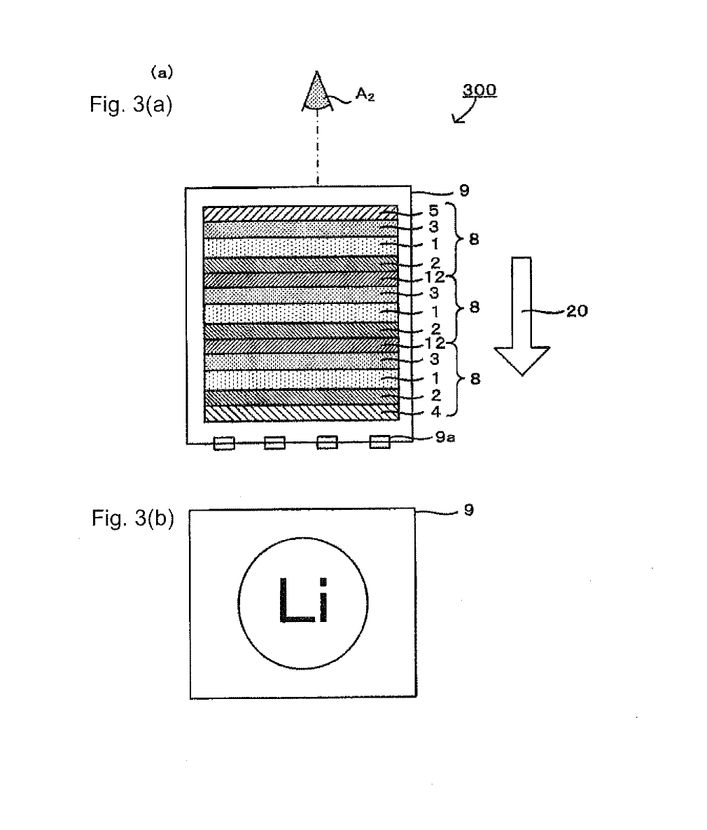

FIG. 3(a) is a view showing a third typical example of the air battery of the present invention, and it is also a schematic cross-sectional view of the air battery cut in the laminating direction. An arrow 20 indicates the vertical direction.

As shown in FIG. 3(a), each laminate 8 comprises the following: an air electrode comprising an air electrode layer 2 and an air electrode current collector 4 (or a current collector 12); an anode comprising an anode active material layer 3 and an anode current collector 5 (or a current collector 12); and a liquid electrolyte layer 1 sandwiched between the air electrode and the anode. Moreover, each current collector 12 is shared by the air electrode and anode of adjacent laminates 8. The third typical example 300 of the air battery of the present invention, is an air battery in which a bipolar battery is housed in the outer case 9, the bipolar battery comprising the two or more laminates 8 stacked. At both ends of the bipolar structure, the anode current collector 5 and the air electrode current collector 4 are provided. The outer case 9 comprises oxygen intake vents 9a on the side facing the air electrode current collector 4.

As shown in FIG. 3(a), inside the outer case 9, the members are stacked in the following order from the upper side of the vertical direction: anode current collector 5-anode active material layer 3-liquid electrolyte layer 1-air electrode layer 2-current collector 12-anode active material layer 3-liquid electrolyte layer 1-air electrode layer 2-current collector 12-anode active material layer 3-liquid electrolyte layer 1-air electrode layer 2-air electrode current collector 4. In the typical example 300, there is a case in which the anode active material layer 3 and the anode current collector 5 both belonging to one laminate 8, are present on the lower side of the vertical direction, below the liquid electrolyte layer 1 belonging to a different laminate 8. For example, there is a case that said laminate 8, to which the anode active material layer 3 and the anode current collector 5 belong, is present on the lower side of the vertical direction, below the different laminate 8 to which the liquid electrolyte layer 1 belongs. However, in general, the amount of the liquid derived from the liquid electrolyte layer 1 is not enough to seep out to the members of the different laminate. Therefore, even in the typical example 300, the liquid derived from the liquid electrolyte layer does not seep out to the side surfaces of and/or the interface between the anode active material layer and the anode current collector, and thus it is possible to prevent the formation of the internal battery by the anode active material layer, the anode current collector and the liquid derived from the liquid electrolyte layer from occurring.

FIG. 3(b) is a view showing a top surface of the outer case 9, that is, a view showing a surface of the outer case 9 as seen from a viewpoint A₂ in FIG. 3(a). As shown in FIG. 3(b), the third typical example 300 has a mark of “Li” on the top surface of the outer case. This Li mark shows the anode (such as an anode in which a lithium metal is contained in the anode active material layer) is present below the surface. By this Li mark, the top and bottom of the outer case can be determined.

As just described, the third typical example 300 with the Li mark on the top surface of the outer case 9, makes it possible to visually and clearly confirm the top and bottom of the stacked laminates (air battery) from the outside, at the time of installing and/or using the air battery. Therefore, the air battery can be certainly installed and/or used so that the anode active material layer 3 and the anode current collector 5 are on the upper side of the vertical direction and above the liquid electrolyte layer 1 belonging to the same laminate 8.

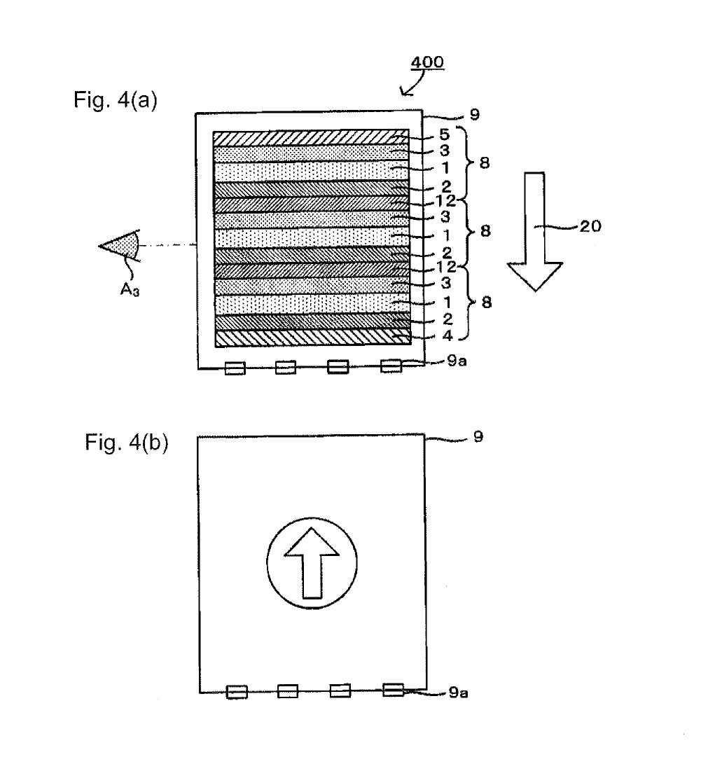

FIG. 4(a) is a view showing a fourth typical example of the air battery of the present invention, and it is also a schematic cross-sectional view of the air battery cut in the laminating direction. An arrow 20 indicates the vertical direction. The internal structure of the outer case 9 is the same as the third typical example described above.

FIG. 4(b) is a view showing a side surface of the outer case 9, that is, a view showing a surface of the outer case 9 as seen from a viewpoint A₃ in FIG. 4(a). As shown in FIG. 4(b), the fourth typical example 400 has a mark of arrow on the side surface of the outer case. By this arrow mark, the top and bottom of the outer case can be determined.

As just described, the fourth typical example 400 with the arrow mark on the side surface of the outer case 9, makes it possible to visually and clearly confirm the top and bottom of the stacked laminates from the outside of the outer case, at the time of installing and/or using the air battery. Therefore, the air battery can be certainly installed and/or used so that the anode active material layer 3 and the anode current collector 5 are on the upper side of the vertical direction and above the liquid electrolyte layer 1 belonging to the same laminate 8.

In the present invention, the air battery can further comprise a housing for housing the one or two or more outer cases stacked.

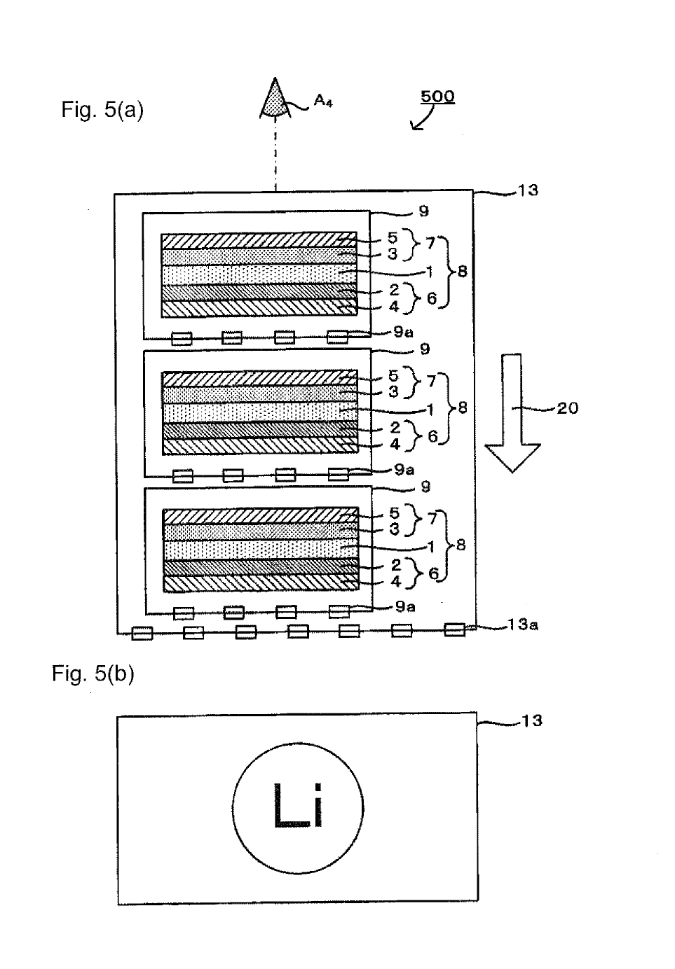

FIG. 5(a) is a view showing a fifth typical example of the air battery of the present invention, and it is also a schematic cross-sectional view of the air battery cut in the laminating direction. An arrow 20 indicates the vertical direction. The internal structure of the outer case 9 is the same as the second typical example described above.

The fifth typical example 500 further comprises a housing 13 for housing the two or more outer cases 9 stacked. The housing 13 comprises oxygen intake vents 13a on the side facing the oxygen intake vents 9a of the outer case 9.

In the typical example 500, there is a case in which the anode active material layer 3 and anode current collector 5 of one outer case 9, are present on the lower side of the vertical direction, below the liquid electrolyte layer 1 of a different outer case 9. However, in general, the amount of the liquid derived from the liquid electrolyte layer 1 is not enough to leak from the oxygen intake vents 9a and seep out to the members of the different outer case. Therefore, even in the typical example 500, the liquid derived from the liquid electrolyte layer does not seep out to the side surfaces of and/or the interface between the anode active material layer and the anode current collector, and thus it is possible to prevent the formation of the internal battery by the anode active material layer, the anode current collector and the liquid derived from the liquid electrolyte layer from occurring.

FIG. 5(b) is a view showing a top surface of the housing 13, that is, a view showing a surface of the housing 13 as seen from a viewpoint A₄ in FIG. 3(a). As shown in FIG. 5(b), the fifth typical example 500 has a mark of “Li” on the top surface of the housing 13. By this Li mark, the top and bottom of the housing 13 can be determined.

As just described, the fifth typical example 500 with the Li mark on the top surface of the housing 13, makes it possible to visually and clearly confirm the top and bottom of the stacked outer cases from the outside of the housing, at the time of installing and/or using the air battery. Therefore, the air battery can be certainly installed and/or used so that the anode active material layer 3 and the anode current collector 5 are on the upper side of the vertical direction and above the liquid electrolyte layer 1 housed in the same outer case 9.

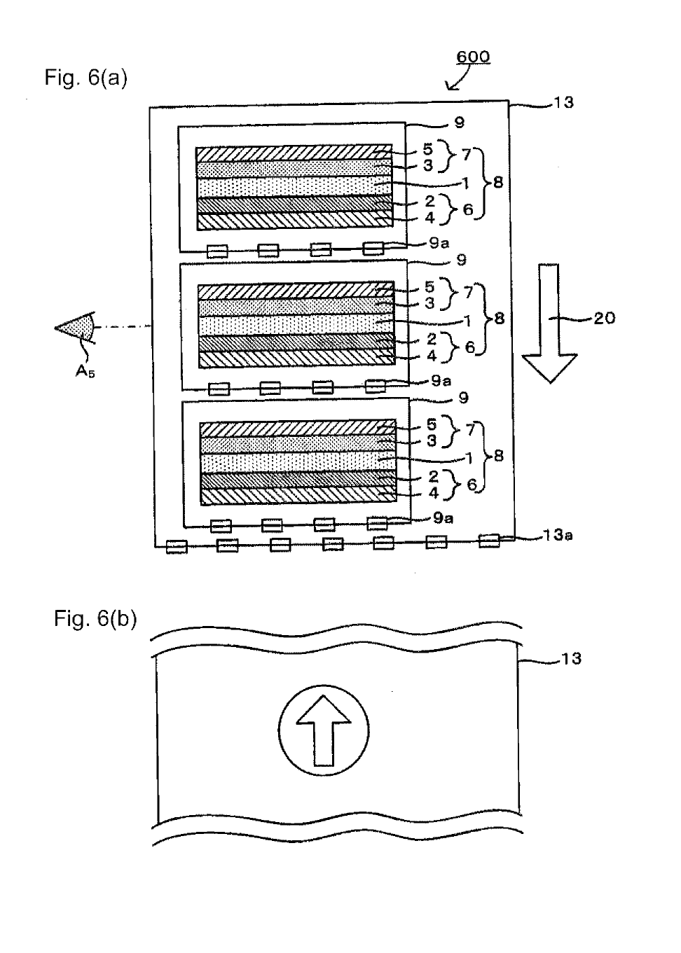

FIG. 6(a) is a view showing a sixth typical example of the air battery of the present invention, and it is also a schematic cross-sectional view of the air battery cut in the laminating direction. An arrow 20 indicates the vertical direction. The internal structure of the housing 13 is the same as the fifth typical example described above. The housing comprises oxygen intake vents 13a on the side facing the oxygen intake vents 9a of the outer case 9.

FIG. 6(b) is a view showing a side surface of the housing 13, which is parallel to the stacking direction of the outer cases 9, that is, a view showing a surface of the housing 13 as seen from a viewpoint A₅ in FIG. 6(a). A double wavy line indicates that the figure is partly omitted. As shown in FIG. 6(b), the sixth typical example 600 has a mark of arrow on the side surface of the housing 13. By this arrow mark, the top and bottom of the housing 13 can be determined.

As just described, the sixth typical example 600 with the arrow mark on the side surface of the housing 13, makes it possible to visually and clearly confirm the top and bottom of the stacked laminates from the outside, at the time of installing and/or using the air battery. Therefore, the air battery can be certainly installed and/or used so that the anode active material layer 3 and the anode current collector 5 are on the upper side of the vertical direction and above the liquid electrolyte layer 1 housed in the same outer case 9.

Hereinafter, the air electrode, the anode, the liquid electrolyte layer and the outer case, which are constituent members of the air battery of the present invention, and a separator that is suitably used in the air battery of the present invention will be explained in detail.

### (Air Electrode)

The air electrode used in the present invention preferably comprises an air electrode layer. In addition to this, the air electrode generally comprises an air electrode current collector and an air electrode lead and/or an air electrode tab, which are connected to the air electrode current collector.

### (Air Electrode Layer)

The air electrode layer used in the present invention comprises at least an electroconductive material. As needed, the air electrode layer can further comprise at least one of a catalyst and a binder.

The electroconductive material used for the air electrode layer is not particularly limited, as long as it is electroconductive. The examples include a carbonaceous material, a perovskite-type electroconductive material, a porous electroconductive polymer and a porous metal material. Especially, the carbonaceous material can be porous or non-porous. However, in the present invention, the carbonaceous material is preferably porous, because a large specific surface area and many reaction sites can be offered. Concrete examples of porous carbonaceous materials include mesoporous carbon. Concrete examples of non-porous carbonaceous materials include graphite, acetylene black, carbon black, carbon nanotubes and carbon fibers. For example, when the mass of the whole air electrode layer is 100% by mass, the content of the electroconductive material in the air electrode layer is preferably 10 to 99% by mass, particularly preferably 50 to 95% by mass. This is because there is a possible decrease in reaction sites and battery capacity when the content of the electroconductive material is too small, and when the content is too large, there is a possible decrease in catalyst content, relatively, and may result in poor catalyst performance.

As the catalyst used in the air electrode layer, for example, there may be mentioned an oxygen-activating catalyst. The examples include platinum group metals such as nickel, palladium and platinum; perovskite-type oxides containing a transition metal such as cobalt, manganese or iron; inorganic compounds containing a noble metal oxide such as ruthenium, iridium or palladium; metal-coordinated organic compounds having a porphyrin or phthalocyanine structure; and manganese oxide. The content ratio of the catalyst in the air electrode layer is not particularly limited. However, for example, when the mass of the whole air electrode layer is 100% by mass, the content ratio is preferably 0 to 90% by mass, particularly preferably 1 to 90% by mass.

From the viewpoint of smooth electrode reaction, the catalyst can be supported by the electroconductive material.

The air electrode layer is needed to contain at least the electroconductive material. However, more preferably, the air electrode layer further contains a binder for fixing the electroconductive material. Examples of binders include rubber resins such as polyvinylidene fluoride (PVdF), polytetrafluoroethylene (PTFE) and styrene-butadiene rubber (SBR). The content ratio of the binder in the air electrode layer is not particularly limited. However, for example, when the mass of the whole air electrode layer is 100% by mass, the content ratio is preferably 1 to 40% by mass, particularly preferably 1 to 10% by mass.

Methods for producing the air electrode layer include, but not limited to, the following method, for example: a method in which materials for the air electrode layer, including the electroconductive material, are mixed and roll-pressed; and a method in which a slurry is prepared by mixing a solvent with materials for the air electrode layer, including the electroconductive material, and then applied to the below-described air electrode current collector. Methods for applying the slurry to the air electrode current collector include known methods such as a spraying method, a screen printing method, a doctor blade method, a gravure printing method and a die coating method.

The thickness of the air electrode layer varies depending on the application of the air battery, etc. For example, the thickness is preferably 2 to 500 μm, particularly preferably 5 to 300 μm.

### (Air Electrode Current Collector)

The air electrode current collector of the air battery of the present invention collects current from the air electrode layer. The material for the air electrode current collector is not particularly limited as long as it is electroconductive. However, the examples include stainless-steel, nickel, aluminum, iron, titanium and carbon. As the form of the air electrode current collector, there may be mentioned a foil form, a plate form and a mesh (grid) form, for example. From the viewpoint of excellent current-collecting efficiency, the air electrode current collector preferably has a mesh form. In this case, generally, the air electrode current collector in a mesh form is provided inside the air electrode layer. In addition, the air battery of the present invention can further comprise a different air electrode current collector (such as a current collector in a foil form) for collecting charge collected by the air electrode current collector in a mesh form. In the present invention, the below-described outer case can also function as the air electrode current collector.

The thickness of the air electrode current collector is, for example, 10 to 1,000 μm, particularly preferably 20 to 400 μm.

### (Anode)

The anode of the air battery of the present invention preferably comprises an anode layer comprising an anode active material. In general, the anode further comprises an anode current collector and an anode lead and/or an anode tab, which are connected to the anode current collector.

### (Anode Layer)

The anode layer of the air battery of the present invention comprises an anode active material containing a metal material, an alloy material and/or a carbonaceous material. Concrete examples of the metal and alloy materials that can be contained in the anode active material, include a lithium metal, a lithium-containing alloy material and a lithium-containing compound.

Examples of lithium-containing alloys include a lithium-aluminum alloy, a lithium-tin alloy, a lithium-lead alloy and a lithium-silicon alloy.

Examples of lithium-containing compounds include a lithium oxide, a lithium sulfide and a lithium nitride. Examples of lithium oxides include a lithium titanium oxide. Examples of lithium nitrides include a lithium cobalt nitride, a lithium iron nitride and a lithium manganese nitride. Also, a solid electrolyte-coated lithium can be used in the anode layer.

The anode layer can be a layer containing only the anode active material, or it can be a layer containing at least one of an electroconductive material and a binder, in addition to the anode active material. For example, when the anode active material is in a foil form, the anode layer can be a layer that contains only the anode active material. On the other hand, when the anode active material is in a powdery form, the anode layer can be a layer that contains the anode active material and the binder. The binder and the electroconductive material will not be explained here since they are the same as those of the air electrode layer explained above under “Air electrode layer”.

### (Anode Current Collector)

The material for the anode current collector of the air battery of the present invention is not particularly limited, as long as it is electroconductive. The material can contain a metal or alloy, and there may be mentioned copper, stainless-steel, carbon, nickel and tantalum, for example. Of them, stainless-steel and carbon are preferably used as the anode current collector. As the form of the anode current collector, there may be mentioned a foil form, a plate form and a mesh (grid) form, for example. In the present invention, the below-described outer case can also function as the anode current collector.

In the present invention, a sufficient corrosion current prevention effect can be obtained especially in the case where a lithium metal is used as the anode active material layer and a metal is used as the anode current collector.

### (Liquid Electrolyte Layer)

The liquid electrolyte layer of the air battery of the present invention is retained between the air electrode layer and the anode layer and functions to exchange metal ions between the air electrode layer and the anode layer.

As the liquid electrolyte layer, there may be used an aqueous liquid electrolyte and a non-aqueous liquid electrolyte. They can be used alone or in combination of two or more kinds.

It is preferable to select the type of the non-aqueous liquid electrolyte appropriately, depending on the type of metal ions to be conducted. For example, as the non-aqueous liquid electrolyte applicable to a lithium-air battery, one containing a lithium salt and a non-aqueous solvent is generally used. Examples of the lithium salt include inorganic lithium salts such as LiPF₆, LiBF₄, LiClO₄ and LiAsF₆; and organic lithium salts such as LiCF₃SO₃, LiN(SO₂CF₃)₂(Li-TFSI), LiN(SO₂C₂F₅)₂ and LiC(SO₂CF₃)₃. Examples of the non-aqueous solvent include ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethylsulfoxide (DMSO) and mixtures thereof. The concentration of the lithium salt in the non-aqueous liquid electrolyte is 0.1 to 1.5 mol/kg, for example.

In the present invention, as the non-aqueous liquid electrolyte or non-aqueous solvent, there may be used low-volatile solvents including ionic liquids as typified by the following: N-methyl-N-propylpiperidinium bis(trifluoromethanesulfonyl)imide (PP13TFSI), N-methyl-N-propylpyrrolidinium bis(trifluoromethanesulfonyl)imide (P13TFSI), N-butyl-N-methylpyrrolidinium bis(trifluoromethanesulfonyl)imide (P14TFSI), N,N-diethyl-N-methyl-N-(2-methoxyethyl)ammonium bis(trifluoromethanesulfonyl)imide (DEMETFSI) and N,N,N-trimethyl-N-propylammonium bis(trifluoromethanesulfonyl)imide (TMPATFSI).

In the case of the liquid electrolyte comprising an organic solvent, a coating film is formed on the anode active material layer surface (e.g., lithium metal surface) and thus the corrosion current as described above is less likely to flow. However, in the case of the liquid electrolyte comprising an ionic liquid, a coating film is not formed on the anode active material layer surface (e.g., lithium metal surface) or a very thin coating film is formed thereon. Therefore, in the case of the liquid electrolyte comprising an ionic liquid, it is highly possible that a corrosion current flows when a potential difference occurs at the interface between the anode active material layer and the anode current collector, and the possibility is higher than the liquid electrolyte comprising an organic solvent.

Of the above non-aqueous solvents, to promote the oxygen reduction reactions described by the above formula (II) or (III), it is more preferable to use a liquid electrolyte solvent that is stable to oxygen radicals. Examples of such a non-aqueous solvent include acetonitrile (AcN), 1,2-dimethoxyethane (DME), dimethyl sulfoxide (DMSO), N-methyl-N-propylpiperidinium bis(trifluoromethanesulfonyl)imide (PP13TFSI), N-methyl-N-propylpyrrolidinium bis(trifluoromethanesulfonyl)imide (P13TFSI) and N-butyl-N-methylpyrrolidinium bis(trifluoromethanesulfonyl)imide (P14TFSI).

It is preferable to select the type of the aqueous liquid electrolyte appropriately, depending on the type of metal ions to be conducted. For example, as the aqueous liquid electrolyte applicable to a lithium-air battery, one containing a lithium salt and water is generally used. Examples of the lithium salt include lithium salts such as LiOH, LiCl, LiNO₃ and CH₃CO₂Li.

### (Separator)

The air battery of the present invention can comprise a separator between the air electrode and the anode. As the separator, for example, there may be mentioned porous films of polyethylene and polypropylene; and non-woven fabrics made of resins such as polypropylene, and non-woven fabrics such as a glass fiber non-woven fabric.

By impregnating these materials with the above-described liquid electrolyte, these materials can be also used as a liquid electrolyte-supporting material.

### (Outer Case)

The air battery of the present invention comprises the outer case that houses the air electrode, the anode, the liquid electrolyte layer, etc. Concrete examples of the form of the outer case include a coin form, a flat plate form, a cylindrical form and a laminate form. In the present invention, a laminated film can be also used as the outer case.

The outer case can be an open-to-the-atmosphere battery case or a closed battery case. The open-to-the-atmosphere battery case is a battery case that has a structure in which at least the air electrode layer can be sufficiently exposed to the atmosphere. On the other hand, when the outer case is a closed battery case, it is preferable that the closed battery case is provided with gas (air) inlet and outlet tubes. In this case, it is preferable that the introduced/emitted gas has a high oxygen concentration, and the gas is preferably dry air or pure oxygen. Also, it is preferable that the oxygen concentration is high at the time of discharge and low at the time of charge.

Depending on the structure of the outer case, an oxygen permeable membrane and/or a water repellent film can be provided inside the outer case.

### (Housing)

The air battery of the present invention can comprise a housing for housing the one or two or more outer cases. The form of the housing can be the same as the outer case.

### 2. Mobile Object

The mobile object of the present invention comprises the air battery.

When installing the air battery in the mobile object of the present invention, the air battery is installed so that the anode active material layer and the anode current collector are always present on the upper side of the vertical direction and above the liquid electrolyte layer. The positions of the anode active material layer, the anode current collector and the liquid electrolyte layer can be fixed. Also in the present invention, a part or the whole of the air battery can be made movable and the inclination of a part or the whole of the air battery can be controlled so that the anode active material layer and the anode current collector are always present on the upper side of the vertical direction and above the liquid electrolyte layer, every time the air battery is used or stopped.

An inclination control system for controlling the inclination of the air battery, etc., can be installed inside the mobile object of the present invention. Examples of the inclination control system include the following: a system for controlling the inclination of the air battery by installing a weight such as ballast; and a system for automatically controlling the inclination of the air battery by working in conjunction with a device for confirming inclination, such as a level.

In addition to this, the mobile object of the present invention can be equipped with various kinds of systems, depending on the application. For example, when the mobile object of the present invention is used as a vehicle such as an automobile, the mobile object can be further equipped with systems such as an internal-combustion engine, a power output member for supplying power to the drive wheels of a vehicle, and a deceleration mechanism for reducing the rotational speed of a motor.

### EXAMPLES

Hereinafter, the present invention will be explained in more detail, by way of examples and comparative examples. However, the present invention is not limited to these examples.

### 1. Production of Air Battery

### Example 1

First, a carbon black (ECP600JD manufactured by Ketjen Black International Company) and a PTFE binder (manufactured by Daikin Industries, Ltd.) were mixed at a ratio of carbon black:PTFE=90% by mass:10% by mass. Next, the mixture was roll-pressed and cut appropriately to produce an air electrode layer. Then, as the air electrode current collector, an SUS mesh (100 mesh of SUS304, manufactured by Nilaco Corporation) was attached to one surface of the air electrode layer, thus obtaining an air electrode.

A liquid electrolyte was prepared in such a manner that a lithium bis(trifluoromethanesulfonyl)imide (manufactured by Kishida Chemical Co., Ltd.) was dissolved in N-methyl-N-propylpiperidinium bis(trifluoromethanesulfonyl)imide (PP13TFSI manufactured by Kanto Chemical Co., Inc.) to a concentration of 0.32 mol/kg and then stirred overnight under an argon atmosphere. Also, a non-woven fabric of polypropylene was used as the separator.

An SUS foil (SUS304 manufactured by Nilaco Corporation) was used as the anode current collector. A lithium metal (manufactured by Honjo Metal Co., Ltd.) was attached to one surface of the SUS foil to produce an anode.

An outer case as shown in FIG. 3, was prepared as the outer case, comprising oxygen intake vents on the air electrode side and a printed mark of “Li” on the anode side.

With the oxygen intake vents-side surface of the outer case down, the members were housed in the outer case so that the members were stacked in the following order from the bottom, thus obtaining the air battery of Example 1: air electrode current collector-air electrode layer-separator impregnated with liquid electrolyte-lithium metal-anode current collector. More specifically, in the air battery of Example 1, the members were stacked in the following order from the upper side of the vertical direction: anode current collector-lithium metal-separator impregnated with liquid electrolyte-air electrode layer-air electrode current collector.

The above processes were all performed in a glove box under a nitrogen atmosphere.

### Comparative Example 1

The air battery of Comparative Example 1 was produced with the same members as those of Example 1, except the outer case. As the outer case of the air battery of the present invention, an outer case having oxygen intake vents on the air electrode side and not having the mark of Li, was used.

With the oxygen intake vents-side surface of the outer case up, the members were housed in the outer case so that the members were stacked in the following order from the bottom, thus obtaining the air battery of Comparative Example 1: anode current collector-lithium metal-separator impregnated with liquid electrolyte-air electrode layer-air electrode current collector. More specifically, in the air battery of Comparative Example 1, the members were stacked in the following order from the upper side of the vertical direction: air electrode current collector-air electrode layer-separator impregnated with liquid electrolyte-lithium metal-anode current collector.

2. Measurement of Voltage of Air Battery after being Allowed to Stand for One Week

The air batteries of Example 1 and Comparative Example 1 were allowed to stand for one week under an inert atmosphere and then measured for cell voltage with a voltmeter. Table 1 shows a comparison of voltage between the air batteries of Example 1 and Comparative Example 1, which were measured after being allowed to stand for one week.

TABLE 1

| | Voltage (V) |
|---|---|
| Example 1 | 2.7 |
| Comparative Example 1 | 2.2 |

As shown in Table 1, the cell voltage of the air battery of Comparative Example 1, which was measured after being allowed to stand for one week, is 2.2 V. It is thought that this is because the liquid derived from the liquid electrolyte seeped out from the liquid electrolyte-impregnated separator and penetrated into the side surfaces of and/or the interface between the lithium metal and the anode current collector, so that the internal battery was formed by the lithium metal, the anode current collector and the liquid derived from the liquid electrolyte.

On the other hand, as shown in Table 1, the cell voltage of the air battery of Example 1, which was measured after being allowed to stand for one week, is 2.7 V. It is thought that this is because the anode current collector and the lithium metal were present on the upper side of the vertical direction and above the liquid electrolyte-impregnated separator, so that the liquid derived from the liquid electrolyte did not penetrate into the side surfaces of and/or the interface between the lithium metal and the anode current collector, so that corrosion of the anode was prevented.

### REFERENCE SIGNS LIST

1. Liquid electrolyte layer
1a, 1b. Liquid derived from liquid electrolyte layer
2. Air electrode layer
3. Anode active material layer
4. Air electrode current collector
5. Anode current collector
6. Air electrode
7. Anode
8. Laminate
9. Outer case
9a. Oxygen intake vents
10. Air electrode current collector tab
11. Anode current collector tab
11a. Notch of anode current collector tab
12. Current collector
13. Housing
13a. Oxygen intake vents
20. Vertical direction
100. First typical example of the air battery of the present invention
200. Second typical example of the air battery of the present invention
300. Third typical example of the air battery of the present invention
400. Fourth typical example of the air battery of the present invention
500. Fifth typical example of the air battery of the present invention
600. Sixth typical example of the air battery of the present invention
700. Conventional air battery
A₁, A₂, A₃, A₄, A₅. Viewpoint

1. An air battery comprising an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer,
wherein the anode comprises at least an anode active material layer and an anode current collector in order from the closest to the liquid electrolyte layer,
wherein the anode active material layer and the anode current collector are present on the upper side of the vertical direction and above the liquid electrolyte layer, and
wherein the air battery comprises a mark indicating at least any one of a state in which the air electrode is resent on the lower side of the vertical direction of the laminate, and a state in which the anode is present on the upper side of the vertical direction of the laminate.

2. (canceled)

3. The air battery according to claim 1, further comprising a housing for housing the one or two or more outer cases stacked,
wherein the mark is provided on a side surface of the housing, the side surface being parallel to the direction of the stacking direction of the outer cases.

4. The air battery according to claim 1, wherein the anode active material layer comprises a lithium metal.

5. The air battery according to claim 1, wherein the anode current collector comprises a metal or alloy.

6. The air battery according to claim 1, wherein the liquid electrolyte layer comprises an ionic liquid.

7. The air battery according to claim 1, wherein the outer case is made of a laminated film.

8. A mobile object comprising any one of the air batteries defined by claim 1.

9. The mobile object according to claim 8, wherein the anode active material layer and the anode current collector are always present on the upper side of the vertical direction and above the liquid electrolyte layer.

10. An air battery comprising an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer,
wherein the anode comprises at least an anode active material layer and an anode current collector in order from the closest to the liquid electrolyte layer, and
wherein the anode active material layer and the anode current collector are present on the upper side of the vertical direction and above the liquid electrolyte layer, so that a liquid derived from the liquid electrolyte layer is not present at side surfaces of and/or an interface between the anode active material layer and the anode current collector.

11. A method for using an air battery comprising an air electrode, an anode, a liquid electrolyte layer and an outer case, the liquid electrolyte layer being present between the air electrode and the anode, and the outer case housing one or two or more laminates each comprising the air electrode, the anode and the liquid electrolyte layer,
wherein the anode comprises at least an anode active material layer and an anode current collector in order from the closest to the liquid electrolyte layer, and
wherein, based on a mark indicating at least any one of a state in which the air electrode is present on the lower side of the vertical direction of the laminate, and a state in which the anode is present on the upper side of the vertical direction of the laminate, the vertical direction of the air battery is determined so that at least at the point of use, the anode active material layer and the anode current collector are present on the upper side of the vertical direction and above the liquid electrolyte layer.

12. (canceled)

13. The method for using the air battery according to claim 11, the air battery further comprising a housing for housing the one or two or more outer cases stacked,
wherein the mark is provided on a side surface of the housing, the side surface being parallel to the direction of the stacking direction of the outer cases.

14. The method for using the air battery according to claim 11, wherein the anode active material layer comprises a lithium metal.

15. The method for using the air battery according to claim 11, wherein the anode current collector comprises a metal or alloy.

16. The method for using the air battery according to claim 11, wherein the liquid electrolyte layer comprises an ionic liquid.

17. The method for using the air battery according to claim 11, wherein the outer case is made of a laminated film.
